(19) United States
(12) Patent Application Publication
(10) Pub. No.: US 2026/0364840 A1
(43) Pub. Date: Nov. 19, 2026

(54) METHOD AND DEVICE FOR SEPARATING BAND-SHAPED MATERIAL USING CUTTING BLADES

(71) Applicant: GROB-WERKE GmbH & Co. KG, MINDELHEIM (DE)

(72) Inventors: Maximilian BOSCH, DETTINGEN AN DER ILLER (DE); Alexander FRITZ, SCHIESSEN (DE)

(21) Appl. No.: 19/673,626

(22) Filed: May 11, 2026

(30) Foreign Application Priority Data
May 13, 2025 (EP) 25176073.2
Sep. 9, 2025 (EP) 25201126.7

(51) Int. Cl. B26D 1/40; B26D 7/26; B65H 35/00

(52) U.S. Cl. CPC B26D 1/405; B26D 7/2628; B65H 35/0086

(57) ABSTRACT

A cutting device and a cutting method by which a continuous material web is conveyed to a cutting zone at a conveying speed and the material web is cut there with a first cutting blade and a second cutting blade which are moved toward and away from each other to cut off a component. The respective cutting blade engaging the web is moved along with the web in the conveying direction at the conveying speed until cutting is completed and the cutting blades have been moved out of the plane of the material web again. In the remaining zone, in which the cutting blades do not engage the web, the cutting blades may be moved at an angular speed so that they meet the web again at a predetermined distance corresponding to the desired component geometry, for a new cut.

### CROSS-REFERENCES TO RELATED APPLICATIONS

This application claims the benefit of European Patent Application Number 25176073.2, filed on May 13, 2025, and European Patent Application Number 25201126.7, filed on Sep. 9, 2025, the entire disclosures of which are incorporated herein by way of reference.

### FIELD OF THE INVENTION

The invention relates to a cutting method for cutting flat material which is band-shaped or arranged in a band-like manner or for separating the band-shaped material into individual components. The invention also relates to a cutting device for cutting flat material which is band-shaped or arranged in a band-like manner or for separating the band-shaped material into individual components.

### BACKGROUND OF THE INVENTION

Preferred applications for the cutting method and the cutting device are material processing in the manufacture of electric energy sources such as, in particular, batteries, and more specifically for electric vehicles. One potential application is battery cell manufacturing, for example. Embodiments of the cutting device and the cutting method serve for example to separate individual battery cell components (e.g. electrodes, separator, monocells, half-cells, etc.) from a material or a composite material (e.g. an intermediate product from preceding process steps) that is supplied in a band-shaped manner.

In other words, the present invention relates to a cutting method and a cutting device for cutting a band-shaped material into individual components, such as electrode (sheets), monocells, half-cells, etc. One could also say that the band-shaped material web is separated into components, sheets, etc.

Cutting devices are known in a great variety. The following cutting devices and methods are currently used, particularly in battery manufacturing:

A cutting device with two mutually oppositely arranged blades which are accelerated linearly - i.e., in the conveying direction of the material web to be cut - along with the material web and cut through it perpendicular to the conveying direction by moving toward each other as soon as the blades move in sync with the material web. Thereafter, the blades are opened again (in the direction perpendicular to the conveying direction), moved away from each other and returned to the starting point. Due to high inertia, high accelerations are required which the cutting device must be capable of achieving. In addition, returning the blades to the starting point (against the conveying direction of the material web) results in a cycle time limit depending on the velocity and the desired component geometry. In other words, due to the movement sequence of the blades, there is a threshold value for cycle times that cannot be fallen below, and thus the reduction in cycle time has a “natural” lower limit.

Another cutting device is based on the concept of two mutually oppositely arranged rollers which are provided with blades and dies and which are accelerated in such a way that the circumferential speed of the rollers corresponds to the conveying speed of the material web. The material web which is fed through the two rollers is then severed by the blades and the dies arranged opposite the blades. However, this cutting device offers little flexibility in terms of customization. In particular, the rollers must be exchanged for each material format - especially with regard to the web width - and/or the circumferential speed must be adjusted and/or the number of blades must be increased or decreased.

### SUMMARY OF THE INVENTION

The object of the invention is to improve cutting of components, in particular as part of a large-scale production of battery cells or the like, in terms of cycle time, space requirements and/or variability.

To achieve this object, the invention provides a cutting method according to one or more embodiments and a cutting device according to one or more embodiments.

In a first aspect, the invention provides a cutting method for cutting a band-shaped material or a flat material arranged in a band-shape, the method comprising:
a) conveying a continuous material web to a cutting zone in a conveying direction at a conveying speed; and
b) cutting the material web transversely to the conveying direction using a first cutting blade and a second cutting blade which are rotationally moved from the first side of the material web and the second side of the material web toward and away from each other to completely severe the material web in between and cut an individual component from the material web, wherein the respective cutting blade engaging the material web is moved along with the material web in the conveying direction at the conveying speed until cutting is complete and the cutting blades have been moved out of the plane of the material web again, characterized in that the first cutting blade and the second cutting blade are substantially aligned perpendicular to the surface of the material web throughout the entire rotational movement.

The cutting method can be used in particular for separating battery cell components from a material web, such as for separating electrodes from an electrode web or for separating half-cells and monocells from a half-cell or monocell string.

Some embodiments of the cutting method include the step to be performed prior to step b):
c) adjusting a movement profile for driving the first and second cutting blades depending on the desired component geometry and the conveying speed.

The term “movement profile” for driving the first and second cutting blades means a predetermined movement sequence comprising sections of different speeds over a full rotation. This way, a movement profile can comprise a synchronous phase and an asynchronous phase. During the synchronous phase, i.e., a predetermined time interval, in which the cutting blades are in contact with the material web, the cutting blades have a speed synchronized with the conveying speed of the material web. In other words, the cutting blades which are in contact with the material web during the synchronous phase move in the conveying direction of the material web at essentially the same speed, in particular at precisely the same speed, as the material web itself. This means, that a tangential speed of the cutting blades which are in contact with the material web essentially, in particular precisely, corresponds to the conveying speed of the material web. During the asynchronous phase, i.e., a predetermined time interval, in which the cutting blades are not in contact with the material web, the speed of the cutting blades is adjusted to a distance that should be present between two cuts. Depending on the conveying speed of the material web, a width of the individual component resulting from the cut can be determined during the asynchronous phase. In other words, the speed of the cutting blades during the asynchronous phase depends on the conveying speed of the material web and the predetermined or predefined (desired) width of the individual component. In summary, these possible speeds can also be referred to as speed variation of the asynchronous phase and the resulting result can also be referred to as cutting width variation. That is to say, the adjustment of the speed for the asynchronous phase enables a virtually stepless adjustment of a width for the individual components.

Some embodiments of the cutting method include the step to be performed prior to step b):
d) providing the first and second cutting blade in a position in which a slit is formed between them through which the material web to be cut is fed.

Some embodiments of the cutting method include the step to be performed prior to step b):
e) providing at least one rotary drive element for driving the first and/or the second cutting blade.

Some embodiments of the cutting method include the step to be performed prior to step b):
f) providing a first rotary drive element for driving the first cutting blade and a second rotary drive element for driving the second cutting blade, and coupled driving of the first and second rotary drive element.

Some embodiments of the cutting method include the step to be performed prior to step b):
g) providing a first cutting cartridge having a first cutting blade on a rotatable first eccentric element and providing a second cutting cartridge having the second cutting blade on a second eccentric element, wherein the eccentric elements are configured to move in mutually opposite directions during cutting operations.

Some embodiments of the cutting method include the step of:
i) adjusting a preload of the cutting blades against each other.

Some embodiments of the cutting method include the step of:
ii) adjusting a blade angle of at least one cutting blade.

Some embodiments of the cutting method include the step of:
iii) providing at least one of the cutting edges with a rotary joint and/or a preferably adjustable preloading element.

Some embodiments of the cutting method include the step of:
iv) providing at least one of the cutting blades with a curvature transversely to the movement direction of the cutting blade, so that the cutting blades only touch in areas or in point-like manner.

Some embodiments of the cutting method include the step of:
v) cutting with a curved cutting blade that is preloaded against the other cutting blade.

In some embodiments, the curvature of the blade is produced in advance by mounting the blade to the cutting cartridge (or to an adapter plate of the cutting cartridge) in a correspondingly preloaded manner. Ideally, no further deformation occurs when the blades are moved past each other. Instead, the curvature of one blade ensures that when the blades are moved past each other, they ideally touch at only two points. For example, the contact begins on the outside and then moves inward as the blades move toward each other. This has the advantage that “pushing” of the material to be cut is reduced or prevented, which in the worst case could lead to “throw-up” of the material and to a poorly cut edge in the region of the “thrown-up” material. This means that the partial and localized contact between the blades allows for a clean cut (and thus a clean cutting edge).

Some embodiments of the cutting method include the step of:
vi) adjusting a cutting gap, in particular by adjusting a preload of the cutting blades to each other and/or adjusting a distance of the cutting blades to each other.

Some embodiments of the cutting method include the step of:
vii) driving the rotational movement of at least one or both cutting blades from both sides by means of independently controllable actuators.

Some embodiments of the cutting method include the step of:
viii) driving the rotational movement of the first cutting blade by means of a first and third motor and driving the rotational movement of the second cutting blade by means of a second and fourth motor and adjusting the preload of the cutting blades to each other and/or adjusting the blade angle of the cutting blades by controlling the motors.

In some embodiments, step b) comprises the step:
b1) moving the first and second cutting blades past each other while contacting each other to cut the material web in between.

In some embodiments, step b) comprises the step:
b2) guiding the first and second cutting blades against each other by means of blade tabs formed on the cutting blades.

In some embodiments, step b) comprises the step:
b3) preloading the first and second cutting blades relative to each other with a defined force in a direction transverse to the blade movement direction.

In some embodiments, step b) comprises the step:
b4) moving the cutting blades in such a way that the cutting blades dive through the plane of the material web essentially at the same time and thus cut the material web and are then moved out of the plane of the material web again.

In some embodiments, step b) comprises the step:
b5) rotationally moving the cutting blades on eccentric elements.

In some embodiments, step b) comprises the step:
b6) aligning the first cutting cartridge and the second cutting cartridge with each other via a guide system.

The guide system can physically couple the two cutting cartridges to each other. For example, the guide system can be designed as a ball bushing guide. Such physical coupling of the two cutting cartridges for their mutual alignment is particularly advantageous in the case where merely the driving shaft of one cutting cartridge is actively driven and the driving shaft of the other cutting cartridge is coupled to the driving shaft of said one cutting cartridge via a transmission and is thus driven indirectly.

Alternatively, the guide system can also guide each of the cutting cartridges individually. In this case, in particular, the guide system is designed in such a way that the cutting cartridge is movable back and forth in a direction substantially perpendicular to the conveying direction of the material via a first guide system unit and is movable back and forth in a direction substantially parallel to the conveying direction of the material web via a second guide system unit. In particular, the first guide system unit and the second guide system unit are coupled to each other in such a way that the first guide system unit is movable back and forth in the direction substantially parallel to the conveying direction of the material web by the second guide system unit. Such a guide system is particularly advantageous when the driving shaft of one cutting cartridge and the driving shaft of the other cutting cartridge can each be actively driven separately from each other. In such a case, the mutual alignment of the cutting cartridges takes place by means of open-loop control / closed-loop control.

Some embodiments of the cutting method include the step to be performed prior to step b):
h) returning the first and second cutting blades to an initial position with a gap in between through which the material web is subsequently fed for cutting the next component.

In this context, the term “gap” is to be understood as an essentially horizontal free space that is formed when the two cutting blades are returned to their respective initial position. The initial position of the upper cutting edge is, in particular, the top dead center and the initial position of the lower cutting blade is, in particular, the bottom dead center.

According to another aspect, the invention provides a cutting device for cutting a material web into individual material pieces or components, the cutting device comprising a mechanical cutting unit and a material web supply device for providing a continuous material web at the cutting unit in such a way that the material web is conveyed to the cutting unit at an adjustable conveying speed, wherein the mechanical cutting unit is provided with a first cutting blade and a second cutting blade which are movable toward and away from each other to cut the material web in between and wherein the respective cutting blade engaging the material web is moved along with the material web in the conveying direction at the conveying speed until cutting is completed and the cutting blades are moved out of the plane of the material web again.

In particular, the cutting device can be used for separating battery cell components from a material web, such as for separating electrodes from an electrode web or for separating half-cells or monocells from a half-cell or monocell string.

In some embodiments of the cutting device, it is provided that the mechanical cutting unit is configured for stepless adjustment of the component geometry to be cut, wherein a distance between two successive cuts on the material web is adjustable in a stepless manner.

Embodiments of the cutting device are designed to perform the cutting method according to any one of the preceding configurations.

In some embodiments of the cutting device, it is provided that the cutting unit has a driving unit for driving the movement of the cutting blades, which driving unit is configured in such a way that a driving profile of the driving unit can be adjusted corresponding to a desired component geometry depending on the conveying speed.

The term “driving profile” for driving the movement of the cutting blades is understood to be a movement sequence of the driving unit tailored to the movement profile of the cutting blades. This means that the driving unit is configured to move the cutting blades in such a way that a predetermined cutting width, i.e., a predetermined distance between to cuts, is achieved at a predetermined conveying speed of the material web. In other words, the driving profile of the driving unit corresponds to a predetermined movement sequence which - referred to a complete rotation, i.e., a movement of the cutting blade by 360° - may include sections with different driving speeds.

In some embodiments of the cutting device, it is provided that the driving unit comprises a computer-implemented control unit that is configured to control the movement of the cutting blades in such a way that the cutting blades, when engaging the electrode web for cutting, move along with the material web in the conveying direction at the conveying speed and otherwise move away from the material web and again toward the material web transversely to the conveying direction in such a way that, when engaging the material web again, a steplessly adjustable length of the material web has been conveyed between the cutting blades.

In some embodiments of the cutting device, it is provided that the driving unit comprises at least one rotary drive element for driving the movement of the cutting blades.

In some embodiments of the cutting device, it is provided that the driving unit comprises a first rotary drive element for driving the first cutting blade and a second rotary drive element for driving the movement of the second cutting blade.

In some embodiments of the cutting device, it is provided that the driving unit comprises at least one motor which is drivable in accordance with a predetermined driving profile.

In some embodiments of the cutting device, it is provided that the driving unit each comprises one motor per side (directed transversely to the conveying direction) to drive the first cutting blade and/or the second cutting blade from one side respectively, wherein the motors are controlled synchronously.

In some embodiments of the cutting device, it is provided that the driving unit comprises a first to fourth motor, wherein the first and third motor drive the cutting blade from different sides and the second and fourth motor drive the second cutting blade from different sides.

In some embodiments of the cutting device, it is provided that the driving unit comprises at least one transmission for coupling the movement of the first and the second cutting blades.

In some embodiments of the cutting device, it is provided that the driving unit comprises a rotary feedthrough for control means and/or a control fluid for adjusting the blade angle and/or preload of the first and/or second cutting blade.

In some embodiments of the cutting device, it is provided that the driving unit comprises a first eccentric element on which the first cutting cartridge, which comprises the first cutting blade, is arranged and a second eccentric element on which the second cutting cartridge, which comprises the second cutting blade, is arranged.

In some embodiments, it is provided that the eccentric elements are rotatable in opposite directions.

In some embodiments, it is provided that the eccentric elements are adjustable in terms of their eccentricity.

In some embodiments, it is provided that the eccentric elements are arranged in opposite directions in such a way that when one eccentric element is at a top dead center, the other eccentric element is at a bottom dead center.

In some embodiments of the cutting device, it is provided that the first and second rotary drive element are eccentric shafts acting as eccentric elements which are coupled to each other by means of the transmission, in particular by means of a toothed belt.

In some embodiments of the cutting device, it is provided that the cutting unit comprises a first cutting cartridge for holding the first cutting blade and a second cutting cartridge for holding the second cutting blade, in a way to be exchangeable, and comprises a supporting device.

In other words, the cutting cartridges are designed to receive and guide the respective cutting blade in such a way that the respective cutting blade is always aligned substantially (+/- 10%) perpendicular, i.e., essentially vertical, to the material web, in particular to a surface of the material web, during the entire rotational movement. In other words, the cutting cartridges are designed to prevent twisting of the cutting blades. For example, a frame or a rack, in particular a welded rack, is provided as a support device.

In some embodiments of the cutting device, a preload adjusting device for adjusting a preload of the cutting blades against each other is provided.

In some embodiments of the cutting device, a blade angle adjusting device for adjusting the blade angle of at least one cutting blade is provided.

In some embodiments of the cutting device, it is provided that at least one of the cutting blades is pivotally mounted by means of a rotary joint, particularly in such a way that a preferably adjustable preloading device preloads the cutting blade, which is pivotable by means of the rotary joint, against the other cutting blade.

In some embodiments of the cutting device, it is provided that the cutting blades are movable in opposite directions to each other while contacting each other.

In some embodiments of the cutting device, it is provided that the cutting blades have blade tabs by which they touch each other during the entire movement sequence.

In some embodiments of the cutting device, it is provided that the cutting blades have slanted cutting edges.

In some embodiments of the cutting device, it is provided that the cutting blades have V-shaped cutting edges.

In some embodiments of the cutting device, it is provided that the cutting blades are aligned substantially perpendicular to the surface of the material web during their movement.

In some embodiments of the cutting device, it is provided that the cutting blades are preloaded against each other in the direction of contact with a predetermined and/or adjustable force.

In some embodiments of the cutting device, it is provided that at least one of the cutting blades is curved transversely to the movement direction of the cutting blade in such a way that the cutting blades only touch in areas or in a point-like manner.

Some embodiments of the cutting device comprise a computer-implemented control unit which is configured to cause the cutting device to perform the cutting method according to any one of the above-described embodiments.

Preferred embodiments of the invention are used in a method for producing monocells.

Preferred embodiments of the cutting device according to the invention are intended to be incorporated into a production plant for the production of monocells and, preferably, meet at least some or all of the following system and process requirements:
A continuous material web, e.g., electrode web, should be cut “on-the-fly” into individual material sheets, e.g., electrode sheets.
The cutting device should be space-efficient and, in particular, capable of being retrofitted into an existing system.
A required format-independent minimum clock frequency (e.g., approximately 10 Hz) should be met.
The material cutting process is designed to work regardless of the material type - that is, regardless of whether the material web being cut is an anode or cathode, a separator web, or a half-cell or single-cell string.
The component width, e.g., the electrode width (cut-to-cut) should be variably/steplessly adjustable for the required component formats, e.g., electrode formats.

In some embodiments, the cutting device comprises a structure by which a mechanical, in particular rotational cut is made transversely to the material web. With this cut, a continuous material web that is continuously fed in a conveying direction by means of an upstream conveying system, is separated into individual sheets of material (= components) transversely to the flow direction of the material. Furthermore, in some embodiments, the cutting device enables stepless adjustment of the sheet geometry of the material (length or width of the material) to be cut. This means that a distance between two successive cuts can be adjusted in a stepless manner.

### BRIEF DESCRIPTION OF THE DRAWINGS

Exemplary embodiments will be described in more detail in the following with reference to the attached drawings, wherein it is shown by:

FIG. 1 a perspective view of an electrode cutting device according to a first embodiment;

FIG. 2 a side view of the electrode cutting device according to FIG. 1;

FIG. 3 a sectional view of the electrode cutting device along line A-A of FIG. 2;

FIG. 4 a sectional view of the electrode cutting device along line B-B of FIG. 3 to illustrate an example of a driving unit of the electrode cutting device according to the first embodiment;

FIG. 5 a sequence of schematic side views of a mechanical cutting unit of the electrode cutting device in the course of an electrode cutting process for cutting electrodes from a web-like electrode material;

FIG. 6 a schematic side view of parts of the mechanical cutting unit of an electrode cutting device according to a second embodiment;

FIG. 7 a front view of cutting blades of an electrode cutting device according to a third embodiment;

FIG. 8 a view of the cutting blades of the cutting unit of FIG. 7 from above; and

FIG. 9 a sectional view similar to FIG. 3 of the electrode cutting device, where a driving unit of the electrode cutting device according to a fourth embodiment is shown in the right half of the image and a driving unit of the electrode cutting device according to a fifth embodiment is shown in the left half of the image.

### DETAILED DESCRIPTION OF THE PREFERRED EMBODIMENTS

The attached drawing figures show different embodiments of a cutting device for cutting a material web into individual components. The electrode cutting device shown in the present configurations is designed as an electrode cutting device 10 by way of example, which cutting device is configured for cutting a material web, which is in the form of an electrode web 12, into individual electrodes 14 (or components). The electrode cutting device 10 comprises a mechanical cutting unit 16 and an electrode web supply device 18 for providing the continuous electrode web 12 at the cutting unit 16. The electrode web supply device 18 is designed - in particular in computer-controlled manner - and configured in such way that the electrode web 12 is conveyed to the cutting unit 16 in a predetermined conveying direction 24 at an adjustable conveying speed v.

The mechanical cutting unit 16 is provided with a first cutting blade 26 and a second cutting blade 28, which are rotationally movable toward and away from each other to cut the electrode web 12 in between.

In this case, the mechanical cutting unit 16 is designed and configured in such a way that the respective cutting blade 26, 28 engaging the electrode web 12 can be moved along with the electrode web 12 in the conveying direction 24 at the conveying speed v until cutting is completed and the cutting blades 26, 28 are moved out of the plane E of the electrode web 12 again.

In the illustrated embodiments, the mechanical cutting unit 16 is configured for stepless adjustment of the electrode geometry to be cut. In particular, a distance between two successive cuts on the electrode web 12 can be adjusted in a stepless manner.

In the illustrated embodiments, the cutting unit 16 comprises a driving unit 30 for driving the movement of the cutting blades 26, 28 which is configured in such a way that a driving profile of the driving unit 30 is adjustable corresponding to a desired electrode geometry depending on the conveying speed v. This takes place in particular by controlling the driving unit 30 in a corresponding manner, for which purpose the driving unit 30 comprises a corresponding computer-implemented control unit 22.

In some embodiments, the computer-implemented control unit 22 is configured to control the movement of the cutting blades 26, 28 in such a way that the cutting blades 26, 28, when they engage the electrode web 12 for cutting, move along with the electrode web 12 in the conveying direction at the conveying speed v and otherwise move away from the electrode web 12 transversely to the conveying direction 24 and toward the electrode web 12 again in such a way that, when the electrode web 12 is engaged again, a steplessly adjustable predetermined length of the electrode web 12 has been fed through between the cutting blades 26, 28.

Under the control of the computer-implemented control unit 22, the electrode cutting device 10 can automatically perform an electrode cutting method for separating electrodes from the electrode web 12, the method comprising the steps:
a) conveying a continuous electrode web 12 to a cutting zone 20 in a conveying direction 22 at a conveying speed v; and
b) cutting the electrode web 12 transversely to the transport direction 22 using the first cutting blade 26 and the second cutting blade 28, which are moved toward and away from each other in a rotary movement from the first side (here, for example, the underside) of the electrode web 12 and from the second side (here, for example, the upper side) of the electrode web 12, moving them rotationally toward and away from each other to completely sever the electrode web 12 between them and thus cut an electrode 14 from it, wherein the respective cutting blade 26, 28 engaging the electrode web 12 is moved along with the electrode web 12 in the conveying direction at the conveying speed v until the cutting is complete and the cutting blades 26, 28 have been moved out of the plane of the material web again.

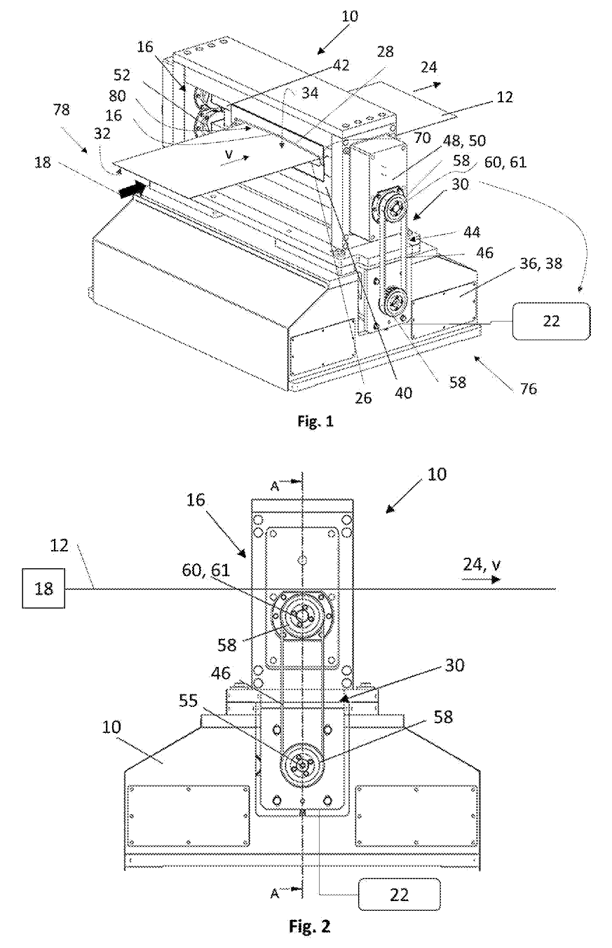

Using the illustration of FIGS. 1-5, a first embodiment of the electrode cutting device 10 and the electrode cutting method is described in more detail below.

FIG. 1 shows a perspective view of the electrode cutting device 10 in accordance with the first embodiment together with the electrode web 12 which is conveyed in the conveying direction 24. FIG. 2 shows the electrode cutting device in a side view from the left.

FIGS. 1 and 2 show an exemplary embodiment of the electrode cutting device 10, which has a design that is as compact as possible and can thus be integrated into an existing system. The electrode cutting device 10 comprises a cutting unit 16, the driving unit 30 and a supporting device 36, such as a frame or rack, in particular a welding rack 38.

According to the illustrated embodiment, the cutting unit 16 is provided with a first cutting cartridge 40, which includes a first cutting blade 26, and a second cutting cartridge 42, which includes a second cutting blade 28. The driving unit 30 comprises, for example, a belt drive 44 with at least one (toothed) belt 46. Further in FIG. 1, a bearing cover 48, which covers a bearing 50, and a mass balancing 52 are shown.

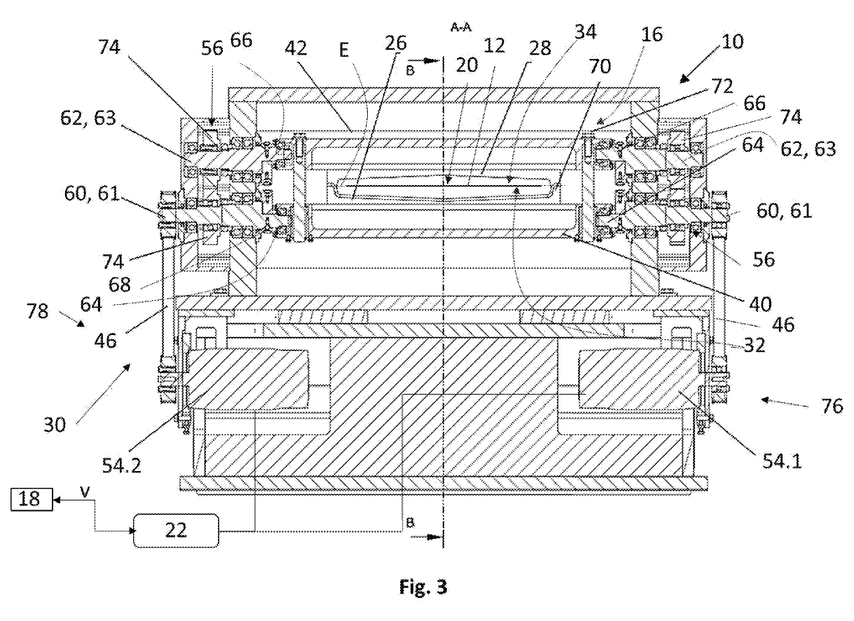

As further shown in FIG. 3, in the illustrated embodiment, the driving unit 30 has two driving devices, in particular motors 54.1, 54.2 and a transmission unit 56, e.g., a gear. The motors 54.1, 54.2 are disposed within the welding rack 38 and are configured to rotationally drive the first (e.g. lower) cutting cartridge 40. The transmission unit 56 is configured to transmit the movement of the first cutting cartridge 40 to the second cutting cartridge 42 at a predetermined transmission ratio, in particular a transmission ratio of 1:1.

The driving unit 30 comprises, for example, two (toothed) belt pulleys 58 (one per cutting cartridge 40, 42), one on the left and one on the right of the electrode web 12, that transmit torque via a (toothed) belt 46. Given the expected high rotational speeds and the motor control system, a (toothed) belt drive - belt drive 44 - could have a positive effect here by serving as a damping element between motors 54.1 and 54.2 and the eccentric shafts.

The first cutting cartridge 40 is coupled at each of its two longitudinal ends to a first driving shaft 60 (an example of a first rotating driving element). The second cutting cartridge 42 is coupled at each of its two longitudinal ends to a respective second driving shaft 62 (example of a second rotating driving element).

In terms of the transmission unit 56, one could also refer to this as a driving shaft 61 (first driving shaft 60 of the first, e.g., lower, cutting cartridge 40) and as driven shaft 63 (second driving shaft 62 of the second, e.g. upper, cutting cartridge 42).

In particular, the cutting cartridges 40, 42 are each coupled (at the two longitudinal ends) to driving shafts 60, 62 in a torque-transmitting manner, so that the motors 54.1, 54.2 of the driving unit 30 drive the two cutting cartridges 40, 42 continuously, but in a predetermined, i.e., previously defined, motor driving profile.

In FIG. 2, the belt drive 44 with the (toothed) belt 46 and the (toothed) belt pulleys 58 on the driven shaft 55 of the motor 54.1 and on the (first) driving shaft 60, 61 is shown. The transmission ratio of the motor 54.1, 54.2 to the first (e.g. lower) driving shaft 60 is in the present case 1:1, but may vary according to the motor design.

Accordingly, among others, the electrode sheet geometry to be cut can be steplessly adjusted by the motor control (motor motion profile). This is achieved through the angular speed of the driving shafts 60, 62 of the cutting cartridges 40, 42 after they have emerged from the electrode material and do not touch the same anymore. In this manner, it can be controlled at which time or after which quantity of continuous electrode material that has been fed through, the two cutting cartridges 40, 42 and correspondingly the cutting blades 26, 28 attached to them move toward each other again and dive into or separate (cut) the electrode material. This also depends on the selected eccentricity and the electrode web speed - conveying speed v – which have to be taken into account when designing the motor profile.

The conveying speed v is preferably constant. For example, the control unit 22 receives a signal indicating the current conveying speed v, and the motors 54.1, 54.2 are controlled depending on that signal.

The driving shafts 60, 62 are provided with an eccentric element 64, 66 (see FIG. 3) whose eccentricity (i.e. the so-called center-to-center distance) may vary depending on the electrode width to be cut and the material flow rate, i.e., the conveying speed v, in the conveying direction 24. It is possible, for example, to adjust the eccentricity by means of an eccentricity adjusting device 68. As already mentioned, a modified center-to-center distance (eccentric) requires a motor driving profile corresponding to the electrode cutting width that can be achieved.

Furthermore, FIG. 3 shows blade tabs 70 and a guide system 72 for guiding the movement of the cutting blade.

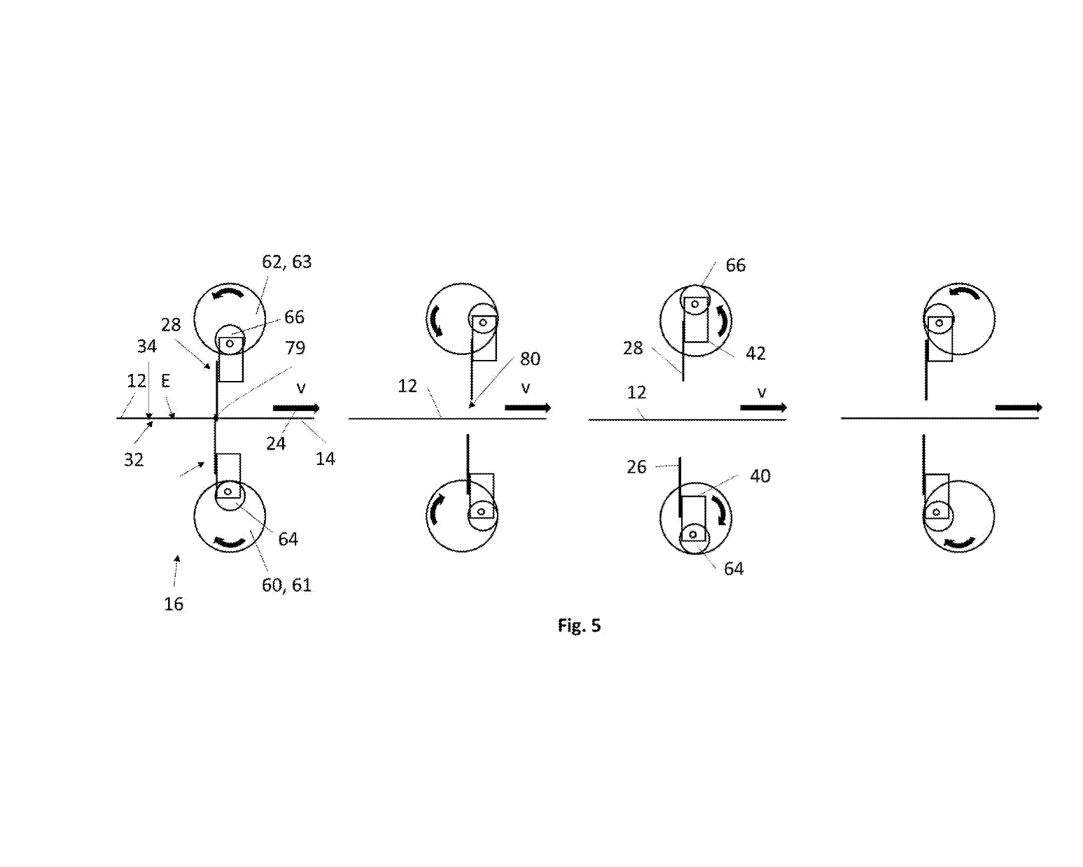

The cutting cartridges 40, 42 are each attached at their longitudinal ends to the eccentric elements 64, 66 of the driving shafts 60, 62 and thus perform a rotational movement that proceeds eccentrically (i.e. out of center) to the center of the driving shaft (see also FIG. 5). In this case, the cutting cartridges are designed in such way that the first (e.g. lower) cutting cartridge 40 and the second (e.g. upper) cutting cartridge 42 are aligned with each other via the guide system (e.g. a ball bushing guide) and/or, in particular, can move toward and away from each other in a circular or, where applicable, elliptical pattern.

It is provided in the first embodiment that the cutting blades 26, 28 attached to the cutting cartridges 40, 42 (e.g. by means of a force fit and/or form fit) are always, that is, throughout the entire rotational movement, aligned vertically with respect to the surface of the electrode web -plane E - (shown schematically in FIG. 5).

As already mentioned above with regard to the transmission unit 56, the driving shafts 61 (first driving shafts 60 of the first, e.g., lower, cutting cartridge 40) are additionally coupled to a driving element (e.g. gear) 74 through which the driven shaft 63 (= second driving shafts 62 of the second, e.g., upper, cutting cartridge 42) located above it is driven at a selected transmission ratio, especially 1:1. It is achieved in this way that both the driving shaft 61 and the driven shaft 63 and thus the cutting cartridges 40, 42 coupled to them are moved with the cutting blades 26, 28 synchronously to each other at the same (rotation) frequency.

The cutting cartridges 40, 42 are each provided with a cutting blade 26, 28, each of which can be exchanged individually and is positively and/or non-positively connected to the respective cutting cartridge 40, 42 (e.g. by a screw connection). The cutting blades 26, 28, which are considered wear parts, can thus be quickly replaced.

The eccentric elements 64, 66 of the eccentric shafts - driving shaft 61 and driven shaft 63 - which are arranged one above the other are disposed in opposite directions. This means that when the second (e.g. upper) eccentric 66 (driven shaft 63) is at the top dead center, the first (e.g. lower) eccentric (driving shaft 61) is at the bottom dead center. The selected drive element (e.g. gear) 74 causes the two eccentric shafts (input and output shafts 61, 63) to rotate in opposite directions. This enables the cutting cartridges 40, 42 mounted on the eccentric shafts 64, 66 to move in a rotational manner and to intersect at a point of elevation corresponding to the electrode web 12, to dive through it, and then to emerge from it again.

In other words, the driving unit 30 and the cutting unit 16 are designed and arranged in such a way that movements of the cutting blades 26, 28 are adjusted to each other so that they dive through the plane E of the electrode web 12 essentially simultaneously, thus intersecting the electrode web 12. Thereafter, the cutting blades 26, 28 are rotationally moved out of the plane E of the electrode web 12 again.

If a gear drive is involved as described above, because of the high rotational speed to be expected, it is advantageous to lubricate the same via a (sealed) gearbox - see bearing cover 48 - or to cool it actively by means of an oil bath, for example. The oil bath itself should also be cooled down actively or the goal should be that it maintains a constant temperature.

The eccentric attachment of the cutting cartridges 40, 42 causes an off-center mass distribution, viewed from the center of the driving shaft 61 or the driven shaft 63, and thus an increased mass imbalance. To compensate for this, each of the four eccentric shafts 60, 62 is additionally equipped with a mass balancing weight - mass balancer 52 - that has been pre-balanced accordingly; this compensates for the mass of the eccentrically positioned cutting cartridge to the extent that the overall center of mass of the eccentrically rotating cutting cartridge 40 42 is mathematically placed on the respective centerline of the eccentric shafts (driving and driven shafts). As a result of this mass balance 52, the forces generated by the rotating cutting cartridges 40, 42 (e.g. centrifugal force) can be kept as small as possible.

FIG. 3 shows a sectional view of the electrode cutting device 10, in which the electrode web 12 is being fed into the plane of the image. It can thus be seen that an almost identical structural configuration has been chosen on both sides 76, 78 adjacent to the electrode web - both to the left and right of the electrode web 12.

It is also apparent from FIG. 3 that the two motors 54.1, 54.2 shown should be synchronized such that the driving and driven shafts 61, 63 of each cutting cartridge 40, 42, arranged on the left and right, rotate as uniformly as possible relative to one another, so that the cutting cartridge 40, 42 arranged thereon does not become distorted, i.e., only small, and in particular no, torsional forces act along its longitudinal axis, and little to no radial forces are induced on the guide system 72 (e.g. ball bushing guide).

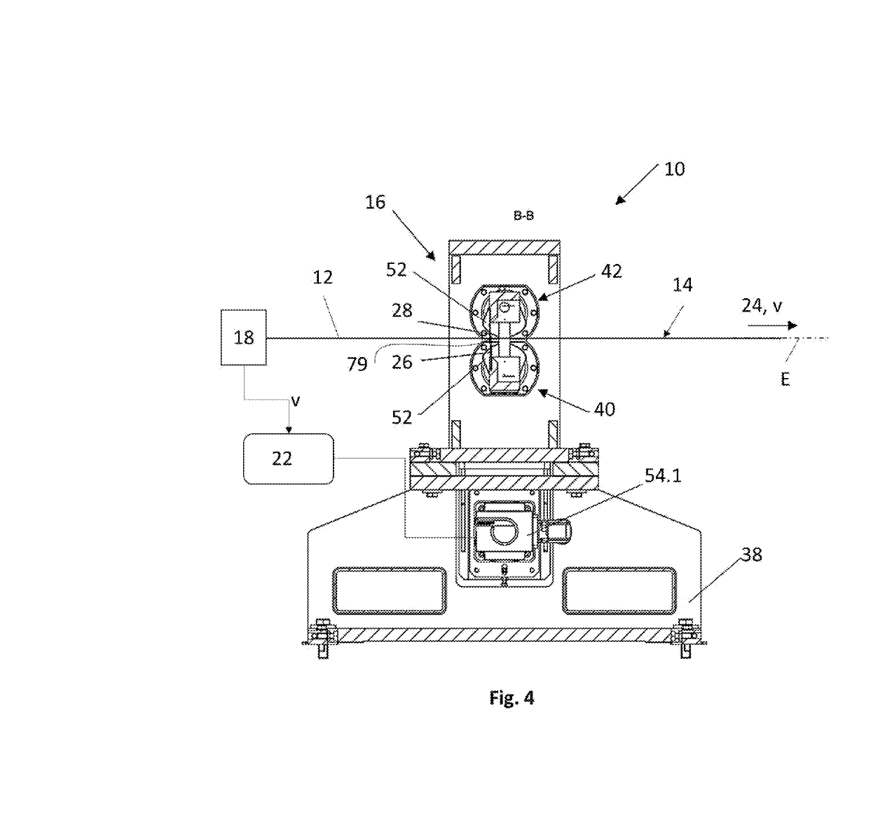

Since its basic design is well known, the electrode web supply device 18 is shown only schematically in FIG. 4. For example, the electrode web is supplied from a supply roll (not shown) and delivered to the cutting area 20 at a conveying speed v via driven rollers (not shown).

In FIG. 4, the direction of material flow - conveying direction 24 - of the electrode web 12 is shown from left to right. It can be seen that the two cutting cartridges 40, 42, with the cutting blades 26, 28 attached thereto, are located at the top and bottom dead centers, respectively. For the intended electrode cut, the upper eccentric shaft - the second driving shaft 60 with eccentric 66 - would now rotate counterclockwise and the lower eccentric shaft - the first driving shaft 62 with eccentric 68 -would rotate clockwise. As a result, the cutting cartridges 40, 42, which are aligned with one another by the guide system 72, move toward each other, with each cutting blade 26, 28 moving along its own circular path, which, however, share a common intersection point 79, see also FIG. 5. FIG. 5 schematically illustrates the rotational movement of the cutting cartridges 40, 42 for cutting the band-shaped electrode material - electrode web 12.

In some embodiments, examples of which will be explained below with reference to the subsequent Figures, the first and second cutting blades 26, 28 provided on the respective cutting cartridges 40, 42 are clamped to each other with a defined force. To this end, the cutting blades 26, 28 should constantly touch, which is achieved, as shown in FIG. 3, by lateral blade tabs 70.

An advantageous configuration of the electrode cutting process, which can be carried out, for example, with the electron cutting device 10 according to the first embodiment shown in FIGS. 1-5, comprises the following process steps:
1. An electrode strand - specifically electrode web 12, e.g. continuous web-shaped electrode material - is pulled through the electrode cutting device 10 in the conveying direction 24 at a continuous material speed - conveying speed v.
2. The motor motion profile is adjusted accordingly based on the required geometry of the electrode sheet to be cut.
3. The cutting cartridges 40, 42 are initially located at the top and bottom eccentric dead center, so that the electrode web 12 can be moved through the resulting “slot” 80 or gap between the upper and lower cutting blades 26, 28.
4. To the extent that the material web - electrode web 12 - is to be separated into individual electrode sheets with a defined electrode width - example for electrodes 14 - the upper eccentric shaft moves counterclockwise (-> in GUZS = counterclockwise) and the lower eccentric shaft moves clockwise (UZS = clockwise) toward each other.
5. As a result, the “slot” 80, or the distance between the upper and lower cutting blades 26, 28, gradually decreases until the cutting blades 26, 28 touch or dive through the electrode band material - electrode web 12 - meaning the material web is finally touched or cut.
6. In this “cutting zone”, the speed component of both cutting blades 26, 28 in the conveying direction 24 is equal to the material flow speed - conveying speed v.
7. Subsequently, the two cutting blades 26, 28 emerge again from the material web - electrode web 12 - whereby a single electrode sheet - electrode 14 - has been separated from the electrode web 12.
8. Depending on when the next electrode cut is to take place, the upper (GUZS) and lower eccentric shafts (UZS) continue to rotate at such an angular speed that they dive into the continuous, replenished electrode web 12 at a defined time and separate it again.

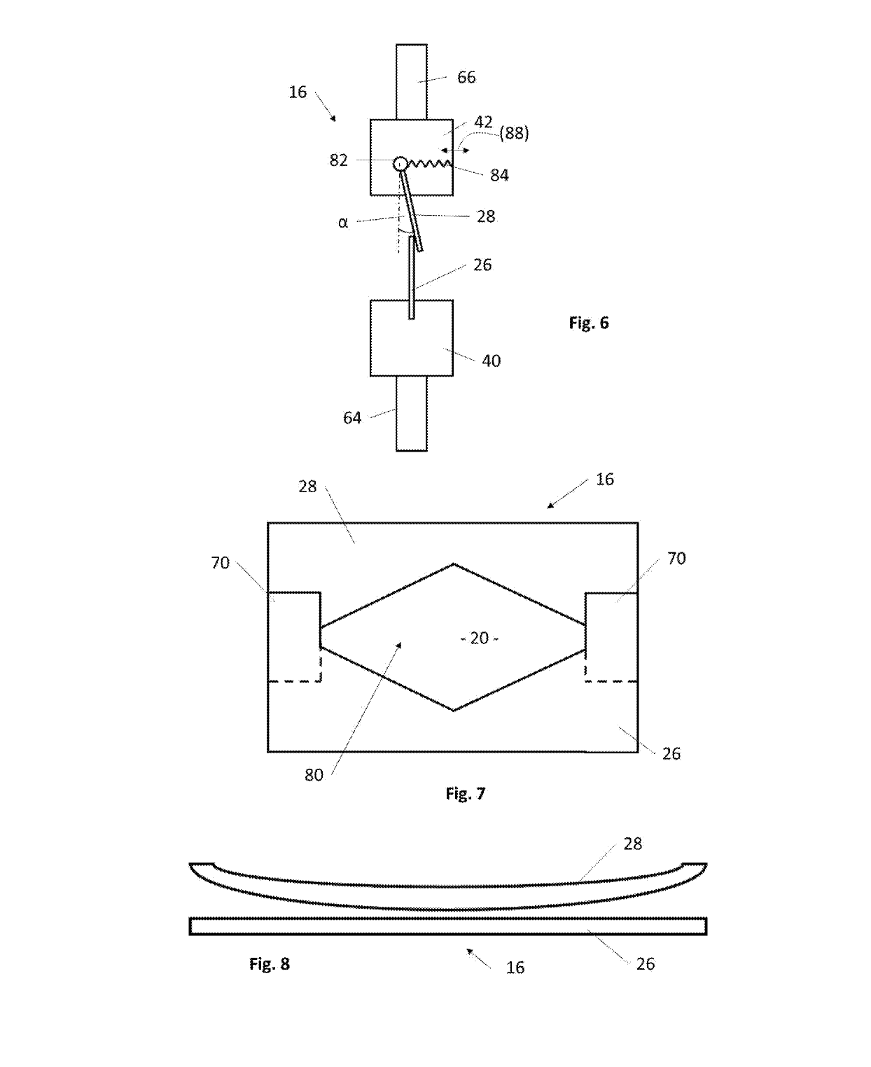

Further embodiments of the electrode cutting device 10 and the electrode cutting method that can be performed therewith are explained below with reference to the illustrations in FIGS. 6-9.

FIG. 6 shows a side view of parts of the cutting unit 16 of the electrode cutting device 10 according to a second embodiment, wherein the first cutting cartridge 40 with the first cutting blade 26 and the second cutting cartridge 42 with the second cutting blade 28 are shown. One of the cutting blades, preferably the upper cutting blade - the second cutting blade 28 - is rotatably mounted via a rotary joint 82. The rotary joint 82 can be adjusted to a specific position via a preloading element 84 - here, for example, a spring element - such that the rotatably mounted cutting blade - preferably the upper, second cutting blade 28 - can be biased against the other cutting blade - here, for example, the lower, first cutting blade 26.

This ensures that a blade angle α can be adjusted via the rotary joint 82 and through a preload applied by the preloading element 84.

This has the advantage that the preload of the cutting blades 26, 28 relative to each other can be adjusted, thereby enabling the adjustment of a cutting gap.

As indicated in FIG. 7, the cutting gap adjustment can be performed via straight, particularly V-shaped cutting blades 26, 28, via blade tabs 70 and/or a gap adjustment device.

FIG. 8 shows the cutting blades of FIG. 7 from above. In the cutting unit 16 of the electrode cutting device 10 shown in FIG. 8 according to a third embodiment, a cutting blade - preferably the upper, second cutting blade 28 - is mounted in a curved (preloaded) manner on an adapter plate of the cutting cartridge 42. This results in only two contact points between the cutting blades 26, 28 during cutting. A better (“clean”) cut edge is thus possible.

The curvature of the cutting blade 28 is created in advance by mounting the cutting blade 28 on the cutting cartridge 42 (or an adapter plate of the cutting cartridge) in a preloaded manner. As the blades are moved past each other, the curvature of one cutting blade 28 ensures that, ideally, the two blades touch only at two points (the contact starts on the outside and then moves inward as the blades move toward each other). The aim of this is to reduce or prevent “pushing” of the material to be cut, which in an unfavorable scenario, can lead to the material being “thrown up” and, in the area of the “thrown-up” material, to an uneven cut edge. In other words, the localized, point-like contact of the blades 26, 28 produces a clean cut (and thus a clean cut edge).

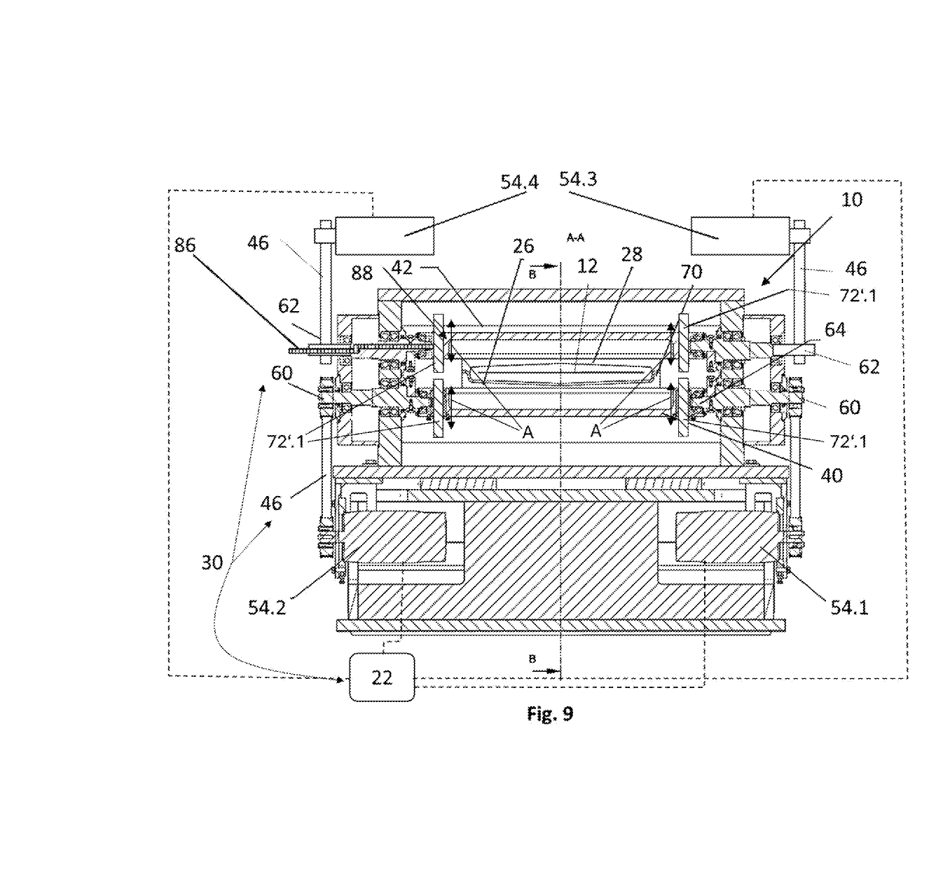

FIG. 9 shows a view similar to that in FIG. 3, wherein the right half of the image shows the configuration of the driving unit 30 of the electron cutting device 10 according to a fourth embodiment, and the left half of the image shows the configuration of the driving unit 30 of the electron cutting device 10 according to a fifth embodiment.

In the fourth and fifth embodiments, not only one motor 54.1, 54.2 but at least two motors are provided on each of the sides 76, 78 laterally to the electrode web 12, wherein a separate motor 54.1, 54.2 is provided for driving the movement of the first cutting blade 26 and a separate motor 54.3, 54.4 is provided for driving the movement of the second cutting blade 28.

For example, a first through fourth motor 54.1-54.4 are provided, wherein a first motor 54.1 and a second motor 54.2 are connected to the first driving shafts 60, which, together with the first eccentric elements 64, drive the first cutting cartridge 40 in a rotary manner, and a third motor 54.3 and a fourth motor 54.4 are connected to the second driving shafts 62, which, together with the second eccentric elements 66, drive the second cutting cartridge 42 in a rotary manner. The transmission unit 56 with the drive elements 74 is not required in these embodiments. The synchronization of the movement is achieved by controlling the first through fourth motors 54.1-54.4 by means of the control unit 22.

Furthermore, the alignment of the cutting cartridges 40, 42 relative to each other is achieved via an alternative guide system 72'. Such a guide system 72' comprises, for each cutting cartridge 40, 42, at least one first guide system component 72'.1 and at least one second guide system component (not shown here). In particular, the guide system 72‘ comprises at least two first guide system components 72‘.1 and at least two second guide system components (not shown) per cutting cartridge 40, 42. The first guide system component(s) 72‘.1 is(are) configured to enable or guide movement of the cutting blades 26, 28 during the rotational movement of the driving shafts in a direction perpendicular to the conveying direction of the electrode web 12 (back and forth, see arrow A in FIG. 9). The second guide system components (not shown here) are configured to enable movement in a direction parallel to the conveying direction of the electrode web 12 (back and forth, into and out of the paper plane in FIG. 9). Furthermore, the first guide system components 72‘.1 are coupled to the second guide system components in such a way that the first guide system components 72‘.1 are guided by the second guide system components during the rotational movement of the driving shafts.

By controlling the motors 54.1-54.4, the preload of the cutting blades 26, 28 relative to each other can also be adjusted. To this end, the motors 54.3, 54.4 driving the second cutting blade 28 are controlled relative to the motors 54.1, 54.2 driving the first cutting blade 26 in such a way that the cutting blades 26, 28 are preloaded toward each other with a specific preloading force. This results in the advantage of better (more precise) adjustment of the preload of the cutting blades 26, 28 toward each other - the preload can also be adjusted “on-the-fly”, i.e., during operation and during the cutting movement, to compensate for fluctuations due to tolerances, for example.

The angles (blade angles α) are also adjustable via the torque of the motors 54.1–54.4.

The fifth embodiment shown on the left in FIG. 9 comprises a rotary feedthrough 86 for control means to control a blade angle and/or preload adjustment device 88 arranged on the cutting cartridge 40, 42. The control means may be configured in various ways. For example, the control means may be configured as a control fluid. For example, the blade angle and/or preload adjustment device 88 operates hydraulically or pneumatically, and the hydraulic or pneumatic pressure for the hydraulic/pneumatic setting of the blade angle/preload of the cutting blades 26, 28 can be adjusted via compressed air or hydraulic fluid (examples of control means/control fluids).

In FIG. 9, the rotary feedthrough 86 is shown only on one side 78; however, some embodiments have a rotary feedthrough 86 on both sides 76, 78 laterally of the electrode web 12. Furthermore, the rotary feedthrough 86 is shown only for the second driving shaft 62, but it may also be provided for the first driving shaft 60.

If the rotary feedthrough 86 is provided on both the first driving shaft 60 and the second driving shaft 62, the blade angle α can be adjusted via the control means and does not need to be adjusted via the torque of the motors 54.1–54.4.

The rotary feedthrough 86 may also be provided in the embodiment shown in FIG. 3, where only two motors are provided.

To improve the separation of electrodes during mass production of battery cells or the like, an electrode cutting device 10 and an electrode cutting method have been proposed, in which a continuous electrode web 12 is conveyed at a conveying speed v to a cutting zone 20, where the electrode web 12 is cut by means of a first cutting blade 26 and a second cutting blade 28, which are moved rotatably toward and away from each other to cut off an electrode 14. The respective cutting blade 26, 28 engaging the electrode web 12 is thereby moved along with the electrode web 12 in the conveying direction 24 at the conveying speed v until cutting is complete and the cutting blades 26, 28 have been moved out of the plane E of the electrode web 12 again. In the remaining zone, where the cutting blades 26, 28 do not engage the electrode web 12, they are preferably moved at such an angular speed that they meet the electrode web 12 again at a predetermined distance corresponding to the desired electrode geometry, for a new cut.

Some advantages of preferred embodiments of the electrode cutting method and the electrode cutting device 10 are:
high format flexibility of the electrode width
electrode cutting width “adjustable” via motor driving profile
unlike, for example, a laser cut, the electrode material is not thermally stressed, so the material properties of the electrode 14 do not change
the electrode strand - electrode web 12 - is cut “on-the-fly”, thereby achieving high cycle times
compactly designed electrode cutting device 10 that can be easily integrated into existing battery manufacturing systems

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 electrode cutting device
12 electrode web
14 electrode
16 cutting unit
18 electrode web supply device
20 cutting zone
22 control unit
24 conveying direction
26 first cutting blade
28 second cutting blade
30 driving unit
32 underside
34 upper side
36 support device
38 welding rack
40 first cutting cartridge
42 second cutting cartridge
44 belt drive
46 (toothed) belt
48 bearing cover
50 bearing
52 mass balancing
54.1 first motor
54.2 second motor
55 driving shaft
56 transmission unit
58 (toothed) belt pulley
60 first driving shaft (example of first rotary driving element)
61 driving shaft of transmission unit (example of rotary driving element)
62 second driving shaft (example of second rotary driving element)
63 driven shaft of transmission unit
64 first eccentric element
66 second eccentric element
68 eccentric adjusting device
70 blade tab
72, 72’ guide system
72’.1 first guide system component
74 driving element (e.g. gear)
76 first side of electrode cutting device (laterally of electrode web)
78 second side of electrode cutting device (laterally of electrode web)
80 slit
82 rotary joint
84 preloading element
86 rotary feedthrough
88 blade angle and/or preload adjusting device
E plane of electrode web
v conveying speed

1. A method for separating a band-shaped material into individual components by cutting, the method comprising:
a) conveying a continuous material web to a cutting zone in a conveying direction at a conveying speed; and
b) cutting the continuous material web transversely to the conveying direction with a first cutting blade and a second cutting blade which are rotationally moved, from a first side of the continuous material web and a second side of the continuous material web, toward and away from each other to completely severe the continuous material web and cut a component from the continuous material web,
wherein the first cutting blade and the second cutting blade, respectively, are moved along with the continuous material web in the conveying direction at the conveying speed when the first cutting blade or the second cutting blade engages the continuous material web until cutting is complete and the first cutting blade or the second cutting blade are moved out of a plane of the continuous material web,
wherein the first cutting blade and the second cutting blade are substantially aligned perpendicular to a surface of the continuous material web over an entire rotational movement.

2. The method according to claim 1, further comprising at least one of the following steps performed prior to step b):
c) adjusting a movement profile for driving the first cutting blade and the second cutting blade depending on a desired component geometry and the conveying speed;
d) providing the first cutting blade and the second cutting blade in a position in which a slit is formed in between, through which the continuous material web is fed;
e) providing at least one rotary drive element for driving the first cutting blade, or the second cutting blade, or both;
f) providing a first rotary drive element for driving the first cutting blade and a second rotary drive element for driving the second cutting blade, and coupled driving of the first rotary drive element and the second rotary drive element; and,
g) providing a first cutting cartridge having the first cutting blade on a rotatable first eccentric element and providing a second cutting cartridge having the second cutting blade on a second eccentric element, wherein the rotatable first eccentric element and the rotatable second eccentric element are configured to move in mutually opposite directions during cutting.

3. The method according to claim 1, further comprising at least one of the following steps:
adjusting a preload of the first cutting blade and the second cutting blade against each other;
adjusting a blade angle of at least one of the first cutting blade and the second cutting blade;
providing at least one of the first cutting blade and the second cutting blade with a rotary joint, or an adjustable preloading element, or both;
providing at least one of the first cutting blade and the second cutting blade with a curvature transversely to a direction of movement of the at least one of the first cutting blade and the second cutting blade, so that the first cutting blade and the second cutting blade only touch in areas or at a point;
cutting with a curved cutting blade preloaded against another cutting blade;
adjusting a cutting gap via an adjustment of a preload of the first cutting blade and the second cutting blade to each other, or an adjustment of a distance of the first cutting blade and the second cutting blade to each other;
driving a rotational movement of at least one of the first cutting blade and the second cutting blade on both with actuators controllable independently of each other; and,
driving a rotational movement of the first cutting blade with a first motor and a second motor and driving a rotational movement of the second cutting blade with a third motor and a fourth motor and adjusting a preload of the first cutting blade and the second cutting blade to each other, or adjusting a blade angle of the first cutting blade and the second cutting blade cutting blades, or adjusting both by controlling one or more of the first to fourth motors.

4. The method according to claim 1, wherein step b) further comprises at least one or more of the following steps:
moving the first cutting blade and the second cutting blade past each other while contacting each other to cut the continuous material web in between;
guiding the first cutting blade and the second cutting blade against each other with blade tabs formed on the first cutting blade and the second cutting blade;
clamping the first cutting blade and the second cutting blade to each other with a defined force in a direction transversely to a blade movement direction;
moving the first cutting blade and the second cutting blade in such a way that the first cutting blade and the second cutting blade dive through a plane of the continuous material web essentially at the same time to cut the continuous material web and then moving the first cutting blade and the second cutting blade out of a plane of the continuous material web;
rotationally moving the first cutting blade and the second cutting blade on eccentric elements; and,
aligning a first cutting cartridge and a second cutting cartridge with each other via a guide system.

5. The method according to claim 1, further comprising, after step b):
returning the first cutting blade and the second cutting blade to an initial position, with a slit in between, through which the continuous material web is subsequently fed for cutting a next component.

6. A cutting device for cutting a material web into individual components according to the method of claim 1, the cutting device comprising:
a mechanical cutting unit; and
a material web supply device for providing the continuous material web to the mechanical cutting unit in such a way that the continuous material web is fed to the cutting unit in the conveying direction at an adjustable conveying speed;
wherein the mechanical cutting unit is provided with the first cutting blade and the second cutting blade,
wherein the first cutting blade and the second cutting blade are substantially vertically aligned to a surface of the continuous material web over an entire rotational movement, and
wherein the first cutting blade and the second cutting blade are, while cutting the continuous material web, movable along with the continuous material web in the conveying direction at the conveying speed until cutting is completed and the first cutting blade and the second cutting blade are configured to be moved out of the plane of the continuous material web.

7. The cutting device according to claim 6, wherein the mechanical cutting unit is configured for a stepless adjustment of a component geometry, and,
wherein a distance between two successive cuts is adjustable in a stepless manner on the material web.

8. The cutting device according to claim 6, wherein the cutting unit further comprises a driving unit for driving a movement of the first cutting blade and the second cutting blade,
wherein the driving unit is configured in such a way that a driving profile of the driving unit is adjustable corresponding to a desired component geometry depending on the conveying speed.

9. The cutting device according to claim 8, wherein the driving unit comprises a computer-implemented control unit which is configured to control a movement of the first cutting blade and the second cutting blade such a way that the first cutting blade and the second cutting blade, when engaging the continuously material web for cutting, move along with the continuous material web in the conveying direction at the conveying speed and otherwise move away from and move back again toward the continuous material web transversely to the conveying direction in such a way that, when the continuous material web is engaged again, a steplessly adjustable predetermined length of the continuous material web has been fed through between the first cutting blade and the second cutting blade.

10. The cutting device according to claim 9, wherein the driving unit comprises at least one rotary drive element for driving the movement of the first cutting blade and the second cutting blade; or
wherein the driving unit comprises a first rotary drive element for driving the movement of the first cutting blade and a second rotary drive element for driving the movement of the second cutting blade; or
wherein the driving unit comprises at least one motor which is drivable in accordance with a predetermined driving profile; or
wherein the driving unit comprises one motor per side to drive the first cutting blade, the second cutting blade, or both from one side each, wherein motors are controlled synchronously; or
wherein the driving unit comprises four motors, wherein a first motor and a second motor drive the first cutting blade from different sides and a third motor and a fourth motor drive the second cutting blade from different sides; or
wherein the driving unit comprises at least one transmission for coupling the movement of the first cutting blade and the second cutting blade; or
wherein the driving unit comprises a rotary feedthrough for control means, or a control fluid, or both for adjusting a blade angle, or a preload of the first cutting blade and the second cutting blade, or both; or
wherein the driving unit comprises a first eccentric element, on which the first cutting blade is arranged, and a second eccentric element, on which the second cutting blade is arranged; or
any combination thereof.

11. The cutting device according to claim 10, wherein the first rotary drive element and the second rotary drive element are eccentric shafts acting as eccentric elements that are coupled to each other by a transmission unit.

12. The cutting device according to claim 6, wherein the cutting unit comprises a first cutting cartridge for holding the first cutting blade and a second cutting cartridge for holding the second cutting blade in such a way that the first cutting blade and the second cutting blade are configured to be exchanged, and comprises a support device; or
wherein a preload adjustment device is provided for adjustment of a preload of the first cutting blade and the second cutting blade against each other; or
wherein a blade angle adjustment device is provided for adjusting a blade angle of at least one of the first cutting blade and the second cutting blade; or
wherein at least one of the first cutting blade and the second cutting blade is pivotably supported by a rotary joint; or
any combination thereof.

13. The cutting device according to claim 6, wherein the first cutting blade and the second cutting blade are movable in opposite directions while contacting each other; or
wherein the first cutting blade and the second cutting blade have blade tabs by which they touch during an entire movement sequence;
wherein the first cutting blade and the second cutting blade have slanted cutting edges; or
wherein the first cutting blade and the second cutting blade have V-shaped cutting edges; or
wherein the first cutting blade and the second cutting blade are aligned substantially perpendicular to a surface of the continuous material web when moved; or
wherein the first cutting blade and the second cutting blade are clamped against each other toward a contact point with a predetermined force, or an adjustable force, or both; or
wherein at least one of the first cutting blade and the second cutting blade is curved transversely to a direction of cutting blade movement in such a way that the first cutting blade and the second cutting blade only touch in areas or at a point.

14. A non-transitory computer readable medium storing a computer program that, when executed by a processor, cause a cutting device to perform the method according to claim 1.
